(19) United States
(12) Patent Application Publication
(10) Pub. No.: US 2015/0053759 A1
(43) Pub. Date: Feb. 26, 2015

(54) SYSTEM, DEVICE AND METHOD FOR IDENTIFYING A SUBJECT AND APPLICATIONS OF SAME

(71) Applicants: William Joseph Cahill, JR., Bremen, GA (US); Suzanne Cahill Manley, Bremen, GA (US)

(72) Inventors: William Joseph Cahill, JR., Bremen, GA (US); Suzanne Cahill Manley, Bremen, GA (US)

(21) Appl. No.: 14/340,907

(22) Filed: Jul. 25, 2014

Related U.S. Application Data
(60) Provisional application No. 61/868,253, filed on Aug. 21, 2013.

(51) Int. Cl. G06K 19/06; G06F 17/30; G06K 19/02

(52) U.S. Cl. CPC G06K 19/06046; G06K 19/022; G06F 17/30386
USPC 235/380; 235/488

(57) ABSTRACT

In one aspect, a device for identifying a subject includes a tattoo layer and a removable cover. The tattoo layer is attachable onto the subject to form a temporary tattoo, and is formed with a resistant material being adhesive such that the temporary tattoo adheres onto the subject. The removable cover detachably covers the tattoo layer. To generate the device, a user may use a computer system to operate a management software to generate the visualization codes including the identification information of the subject, and to print the visualization codes with the resistant material as the tattoo layer on the removable cover. The tattoo layer includes visualization codes thereon, and the visualization codes include identification information of the subject. The user may use a scanner to scan the visualization codes of the tattoo layer to obtain the identification information of the subject, thus identifying the subject.

### CROSS-REFERENCE TO RELATED PATENT APPLICATIONS

This application claims priority to and the benefit of, pursuant to 35 U.S.C. §119(e), U.S. provisional patent application Ser. No. 61/868,253, filed Aug. 21, 2013, entitled “DEVICE CONTAINING INFORMATION AND APPLICATIONS OF SAME,” by William Joseph Cahill, Jr. and Suzanne Cahill Manley, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention relates generally to information identifying technology, and more particular to a system, device and method for identifying a subject, and application of the same.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

Electronic systems become more ubiquitous, there are ongoing efforts directed to coding and managing data in electronic format. Personal data is no exception. In view of the increasing migration toward electronic storage and management of personal data in various environments, there is a need in the art for continued improvement.

Therefore, a heretofore unaddressed need exists in the art to address the aforementioned deficiencies and inadequacies.

### SUMMARY OF THE INVENTION

In one aspect, the present invention relates to temporary tattoo device for identifying a subject, which includes a tattoo layer having a first surface and an opposite, second surface attachable onto the subject to form a temporary tattoo for identifying the subject, and a removable cover detachably covering the first surface of the tattoo layer. The tattoo layer is formed with a resistant material, which is adhesive such that the temporary tattoo adheres onto the subject. The tattoo layer includes visualization codes thereon, and the visualization codes include identification information of the subject. In certain embodiments, the subject may be a patient or a medical object.

In certain embodiments, the resistant material is dissolvable only in a chemical solvent such that the tattoo layer is only removable from the subject using the chemical solvent. In certain embodiments, the chemical solvent is alcohol or baby oil.

In certain embodiments, the resistant material includes a resistant ink, and the tattoo layer is formed on the removable cover by printing with the resistant ink.

In certain embodiments, the removable cover is transparent or semi-transparent such that the visualization codes of the tattoo layer are recognizable through the removable cover. In certain embodiments, the removable cover includes a piece of paper or plastic.

In certain embodiments, the visualization codes include at least one of visualization of optical machine readable codes and text codes. In certain embodiments, the visualization of optical machine readable codes includes at least one of a bar code and a quick response (QR) code.

In certain embodiments, the temporary tattoo is formed onto the subject by: disposing the temporary tattoo device on the subject with the second surface of the tattoo layer facing the subject; applying a force to the removable cover such that the tattoo layer adheres onto the subject to form the temporary tattoo, where the visualization codes of the tattoo layer are recognizable for identifying the subject; and detaching the removable cover from the tattoo layer.

Another aspect of the present invention relates to a system for identifying a subject, which includes a temporary tattoo and a computer system. The temporary tattoo adheres onto the subject, and is formed with a resistant material, where the temporary tattoo includes visualization codes thereon, and the visualization codes include identification information of the subject. The computer system has a processor, an optical scanning device, a printing device, a management software and a database storing information of the subject, where the information of the subject includes the identification information of the subject. The management software, when executed at the processor, is configured to perform the following operations: receiving the identification information of the subject; generating the visualization codes including the identification information of the subject; controlling the printing device to print the visualization codes with the resistant material as a tattoo layer on a removable cover to form a temporary tattoo device, where the resistant material is adhesive such that the tattoo layer is attachable onto the subject to form the temporary tattoo; controlling the optical scanning device to scan the temporary tattoo on the subject and to receive a corresponding scanning signal, where the received scanning signal contains the identification information of the subject; retrieving the identification information of the subject from the received scanning signal; and searching, based on the retrieved identification information of the subject, for the information of the subject stored in the database.

In certain embodiments, the resistant material is dissolvable only in a chemical solvent such that the temporary tattoo is only removable from the subject using the chemical solvent. In certain embodiments, the chemical solvent is alcohol or baby oil.

In certain embodiments, the printing device is an ink jet printer or a laser printer, and the optical scanning device is a scanner.

In certain embodiments, the temporary tattoo is formed onto the subject by: disposing the temporary tattoo device on the subject with the second surface of the tattoo layer facing the subject; applying a force to the removable cover such that the tattoo layer adheres onto the subject to form the temporary tattoo, where the visualization codes of the tattoo layer are recognizable for identifying the subject; and detaching the removable cover from the tattoo layer.

In certain embodiments, the removable cover is transparent or semi-transparent such that the visualization codes of the tattoo layer are recognizable through the removable cover. In certain embodiments, the removable cover includes a piece of paper or plastic.

In certain embodiments, the visualization codes include at least one of visualization of optical machine readable codes and text codes. In certain embodiments, the visualization of optical machine readable codes includes at least one of a bar code and a quick response (QR) code.

In a further aspect of the present invention, a method for identifying a subject is provided. The method includes: receiving identification information of the subject; generating visualization codes including the identification information of the subject; printing the visualization codes with a resistant ink as a tattoo layer on a removable cover to form a temporary tattoo device for identifying the subject, where the resistant ink is adhesive such that the tattoo layer is capable of adhering onto the subject to form a temporary tattoo, and is dissolvable only in a chemical solvent such that the tattoo layer is only removable from the subject using the chemical solvent; forming the temporary tattoo onto the subject with the temporary tattoo device; scanning the temporary tattoo on the subject and receiving a corresponding scanning signal, where the received scanning signal contains the identification information of the subject; retrieving the identification information of the subject from the received scanning signal; and searching, based on the retrieved identification information of the subject, for the information of the subject stored in the subject to identify the subject.

In certain embodiments, the removable cover is transparent or semi-transparent such that the visualization codes of the tattoo layer are recognizable through the removable cover.

In certain embodiments, the step of forming the temporary tattoo onto the subject includes: disposing the temporary tattoo device on the subject with the second surface of the tattoo layer facing the subject; applying a force to the removable cover such that the tattoo layer adheres onto the subject to form the temporary tattoo, where the visualization codes of the tattoo layer are recognizable for identifying the subject; and detaching the removable cover from the tattoo layer.

In certain embodiments, the visualization codes include at least one of visualization of optical machine readable codes and text codes. In certain embodiments, the visualization of optical machine readable codes includes at least one of a bar code and a quick response (QR) code.

These and other aspects of the present invention will become apparent from the following description of the preferred embodiments taken in conjunction with the following drawings, although variations and modifications thereof may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1A shows schematically a front view of a device containing information for identifying a subject according to one embodiment of the present invention.

FIG. 1B shows schematically a side view of the device as shown in FIG. 1A.

FIG. 2 shows schematically production of the device according to one embodiment of the present invention.

FIG. 3 shows a use of the device according to one embodiment of the present invention.

FIG. 4 shows schematically a device containing a sign of instruction as the information of a subject according to one embodiment of the present invention.

FIG. 5A shows a flowchart of the method of identifying a subject according to one embodiment of the present invention.

FIG. 5B shows a flowchart of forming the temporary tattoo onto the subject according to one embodiment of the present invention.

FIG. 6 shows schematically a system for identifying a subject according to one embodiment of the present invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The term “optical machine readable codes”, as used herein, refer to geometric patterns or representations of data which is readable using an optical machine, such as an optical scanner, and corresponding interpretive computer software programs.

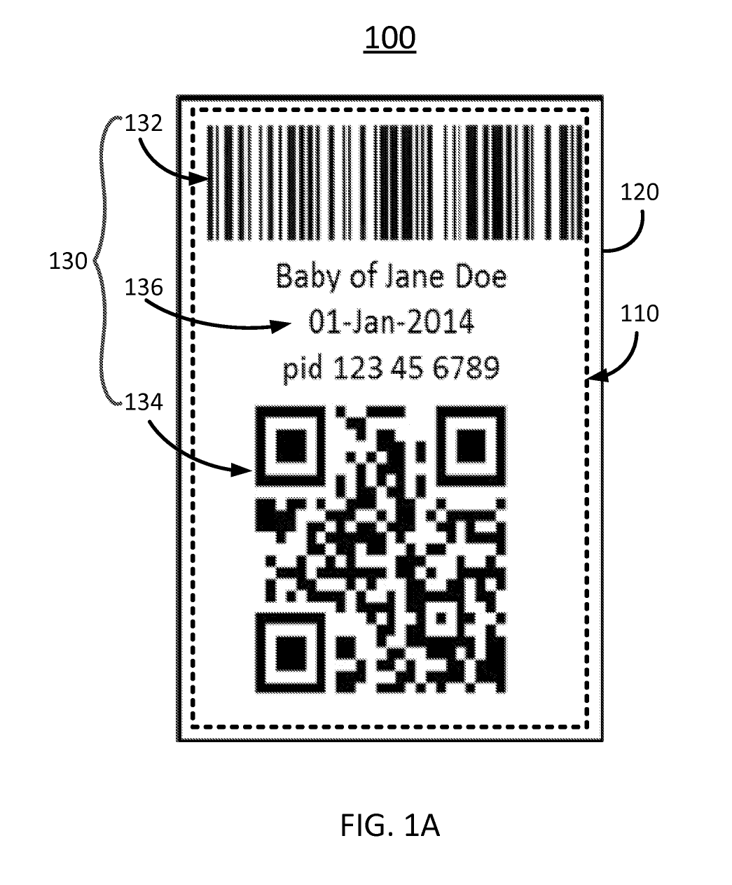

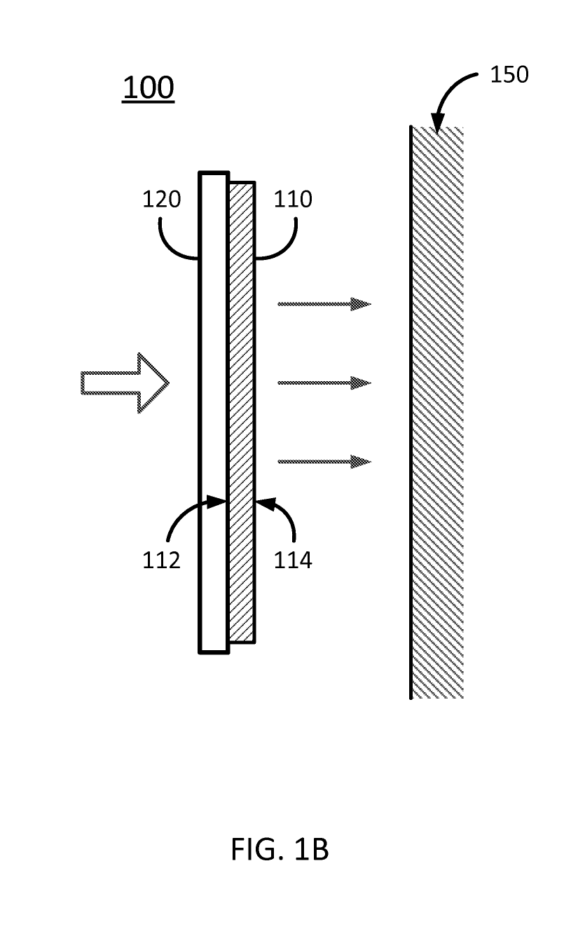

The description is now made as to the embodiments of the invention in conjunction with the accompanying drawings in FIGS. 1A-6. In accordance with the purposes of this invention, as embodied and broadly described herein, the present invention, in different aspects, relates to a system, device and method for identifying a subject. In certain embodiments, the subject may be an object, a human or an animal. Although various exemplary embodiments of the present invention disclosed herein may be described in the context of using medical temporary tattoos for identifying patients, it should be appreciated that aspects of the present invention disclosed herein are not limited to being used in the medical field, and may be practiced in connection with other information identifying usages or occasions without departing from the scope of the present invention disclosed herein.

Currently, electronic medical record management systems used in hospitals utilize patient bracelets for identifying patients. Information of the patient may be provided on the bracelets. However, the bracelets are generally loosely attached to the body or the limbs of the patient, and may be easily removed from the patient. For example, the bracelets may be broken due to patient body movement. A patient may also remove the bracelets voluntarily due to discomfort. When the patient is not a human being but an animal, the animal patient may have the tendency to bite on the bracelet such that the bracelet is destroyed or removed from the body of the animal patient.

One aspect of the present invention relates to a device for identifying a subject. In certain embodiments, the device may be a medical temporary tattoo, which may be used as a medical device for identifying a medical subject. In practice, the subject may be any medical subject related to a medical process, such as a patient being treated with in the medical process, a body part or dissected tissues of the patient, a corpse of dead or expired patient, or a medical object being used or being generated in the medical process. In certain embodiments, the patient may refer to a human patient, or may be an animal patient. In certain embodiments, the medical object may refer to, without being limited, medical instruments, medical consumables or disposables, medicines or chemicals and/or their containers, medical waste, or any other medical or clinical related objects in the medical process.

FIGS. 1A and 1B show schematically a device containing information for identifying a subject according to one embodiment of the present invention, where FIG. 1A shows a front view of the device, and FIG. 1B shows a side view of the device. In this embodiment, the device is a temporary tattoo device, and the subject being identified by the device is a human baby patient. As shown in FIG. 1A, the device has a tattoo layer 110 and a removable cover 120.

The tattoo layer 110 is an information layer, which contains the identification information of the subject. FIG. 1A shows that the tattoo layer 110 includes a plurality of visualization codes 130 thereon. The visualization codes include the identification information of the subject, which in this example is a human baby patient. In certain embodiments, the visualization codes 130 may include visualization of optical machine readable codes or text codes. As shown in FIG. 1A, the visualization codes 130 include a bar code 132 and a quick response (QR) code 134 as two different forms of visualization of optical machine readable codes, and a text code 136. Specifically, the identification information may be identifiable from the text code 136 that the human baby patient is a “Baby of Jane Doe”, was born on Jan. 1, 2014, and has a patient identification (pid) 123 45 6789. The bar code 132 and the QR code 134 are both unique for the baby patient. The unique bar code 132 and QR code 134 may be optically readable (i.e., scan-able) for retrieval of the identification information of the baby patient using corresponding optical machine and corresponding interpretive computer software programs.

As shown in FIG. 1B, the tattoo layer 110 has two surfaces, including a first surface 112 and an opposite, second surface 114. The first surface 112 of the tattoo layer 110 is attached to the removable cover 120, and the second surface 114 of the tattoo layer 110 is attachable onto the subject 150. The tattoo layer 110 is used to form a temporary tattoo on the subject 150 for the purpose of identifying the subject. Thus, the tattoo layer 110 should be capable of staying on the subject 150 to a certain degree without being easily removed from the subject 150. In certain embodiments, the tattoo layer 110 is formed with a resistant material. The resistant material is adhesive such that the tattoo layer 110 may adhere onto the subject 150, and is resistant to water such that the tattoo layer 110 is not easily removable from the subject 150 due to sweat, blood and/or other body fluid that may be generated by the subject 150 during the medical treatment. Thus, the tattoo layer 110 may stay on the subject to be used to identify the subject. In certain embodiments, the resistant material may be dissolvable in a specific chemical solvent, such as alcohol or baby oil, or any other organic chemical solvent. Thus, the tattoo layer 110 is only removable from the subject 150 using the specific chemical solvent to dissolve the resistant material.

The removable cover 120 is a thin sheet, which detachably covers the first surface 112 of the tattoo layer 110. In certain embodiments, the removable cover 120 may be thin enough to be transparent or semi-transparent, such that the visualization codes 130 of the tattoo layer 110 are recognizable through the removable cover 120 without detaching the removable cover 120. For example, the removable cover 120 may be formed with a piece of paper or plastic. Currently, the Food and Drug Administration (FDA) has approved certain temporary tattoo paper or other materials that can be used as the removable cover 120.

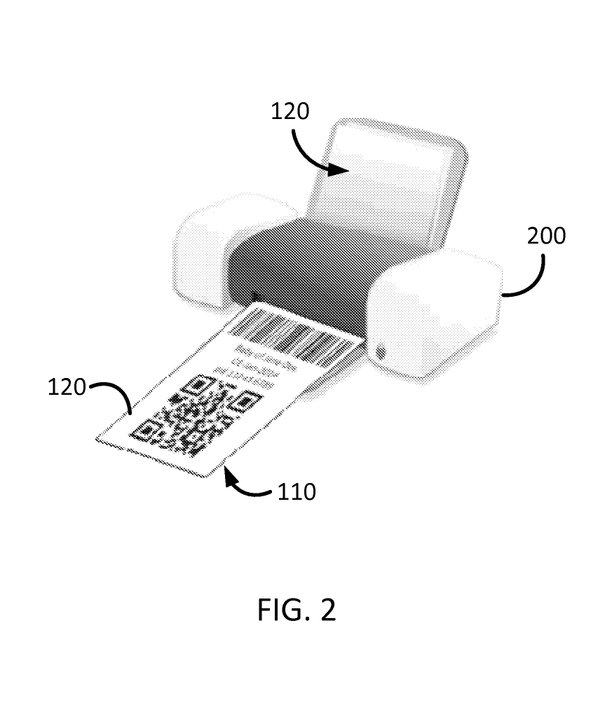

In certain embodiments, the resistant material forming the tattoo layer 110 may be a resistant ink, and the tattoo layer 110 may be formed on the removable cover 120 by printing with the resistant ink. Currently, there are FDA approved inks that may be used as the resistant ink, such as Colorcon® printing inks and other resistant inks. FIG. 2 shows schematically production of the device according to one embodiment of the present invention. As shown in FIG. 2, a printer 200 may be used to print the temporary tattoo device 100. The printer 200 may be an ink jet printer, a laser printer or any other type of printers capable of applying the resistant ink or resistant materials onto the removable cover 120 to form the tattoo layer 110. When the user intends to produce a temporary tattoo device 100 for a subject 150, the user may first obtain identification information of the subject 150, and then use a computer and corresponding software to generate the visualization codes 130, which contains the identification information of the subject 150. Then, the user may use the printer 200 to print the visualization codes 130 on the transparent or semi-transparent removable cover 120 with the resistant ink to form the tattoo layer 110.

The design of the temporary tattoo device makes it easy to apply the temporary tattoo onto the subject. When a user intends to apply the temporary tattoo onto the subject, the user disposes the temporary tattoo device 100 on the subject 150, with the second surface 114 of the tattoo layer 110 facing the subject 150. Then the user applies a force to the removable cover 120 such that the tattoo layer adheres onto the subject 150.

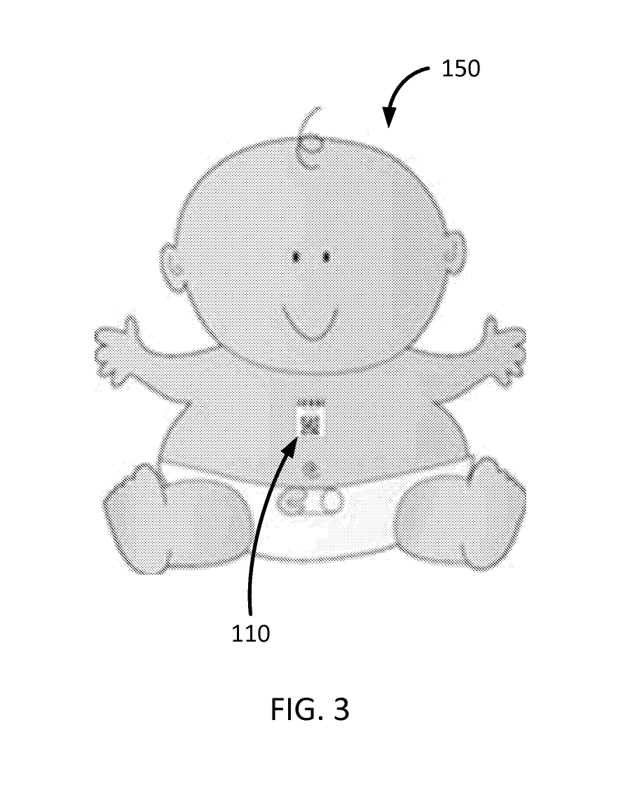

In certain embodiments, the temporary tattoo may adhere onto the subject at any location which the user is easy to locate for identifying the subject. FIG. 3 shows a use of the device according to one embodiment of the present invention. In this embodiment, the subject 150 being identified by the device is a human baby patient. Thus, the temporary tattoo 100 may adhere onto the chest of the baby, which is easy for the nurse and the doctor to identify the baby patient. In certain embodiments, the temporary tattoo may adhere to other locations of the subject. For example, when the subject 150 is a human patient, the temporary tattoo may adhere on the arms, legs, forehead or any other exposed body parts of the patient. When the subject 150 is an animal patient, the temporary tattoo may adhere onto the neck, trunk, tail or any other exposed body parts of the animal. When the subject 150 is a medical object, the temporary tattoo may adhere to any exposing part of the object, or may adhere on the container of the object.

In certain embodiments, the identification information of the subject may include different information based on the nature of the subject. For example, when the subject 150 is a human patient, the identification information may include information of the patient, such as personal data (name, birth date, age, and/or a patient identification), electronic health record (EHR) or electronic medical record (EMR), or any other information related to the patient or medical treatment applied to the patient, such as an instruction to the user (e.g. doctors, surgeons or nurses). When the subject 150 is an animal patient, the identification information may include information of the animal, such as information of owner of the animal, EHR or EMR of the animal, or any other information related to the animal patient, the owner of the animal patient, or medical treatment applied to the patient. When the subject 150 is a dead corpse (e.g., the human patient or the animal patient passed away), the identification information may include information related to the death, such as cause of death and/or death date and time. When the subject 150 is a medical instrument, the identification information may include the name of the medical instrument. When the subject includes medical disposables or medical waste, the identification information may merely include a sign showing “waste”.

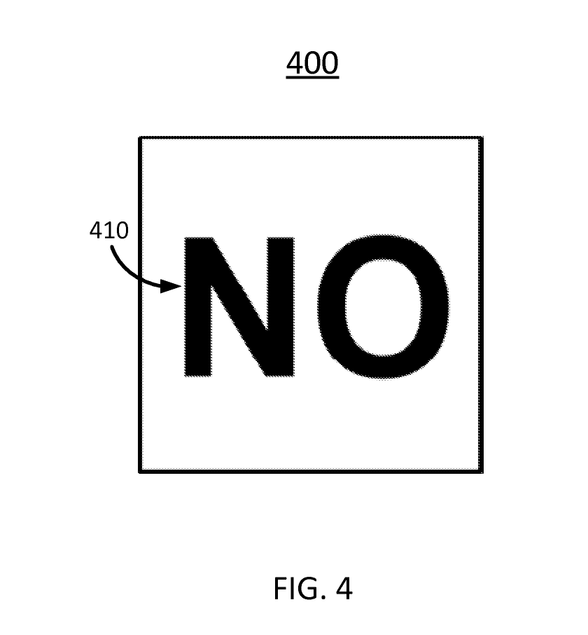

In certain embodiments, the temporary tattoo device 100 may be used for certain instructional, cautious or warning purposes in a medical treatment process. In this case, the identification information may include instructional, cautious or warning text codes or symbols, which is directly recognizable by the user without using a machine. For example, FIG. 4 shows schematically a device containing a sign of instruction as the information of a subject according to one embodiment of the present invention. As shown in FIG. 4, the tattoo layer of the device 400 contains a sign of instruction 410, which shows large sized text “NO”. When a patient is to have a surgery on one limb (e.g., the left arm), a user may apply the temporary tattoo using the device 400 onto the incorrect limbs (e.g., the right arm and the legs) of the patient, such that the surgeons may avoid performing the surgery on any of the incorrect limbs. In certain embodiments, the sign of instruction 410 may include text codes, symbols or other human recognizable codes.

In practical use, removal of the temporary tattoo may be done using the chemical solvent in which the resistant material is dissolvable. Generally, the chemical solvent may be unavailable in the environment of the subject to avoid accidental removal of the temporary tattoo. When the subject is a human or animal patient, the chemical solvent should be safe to be applied to the skin of human or animal patients. In certain embodiments, the chemical solvent may be alcohol or baby oil, and a user may use alcohol or baby oil to wipe out or rub on the temporary tattoo in order to remove the temporary tattoo.

Another aspect of the present invention relates to a method for identifying a subject. In certain embodiments, the method may be implemented by a management software executable on a computer system. In certain embodiments, the management software may be a EHR or EMR management software system.

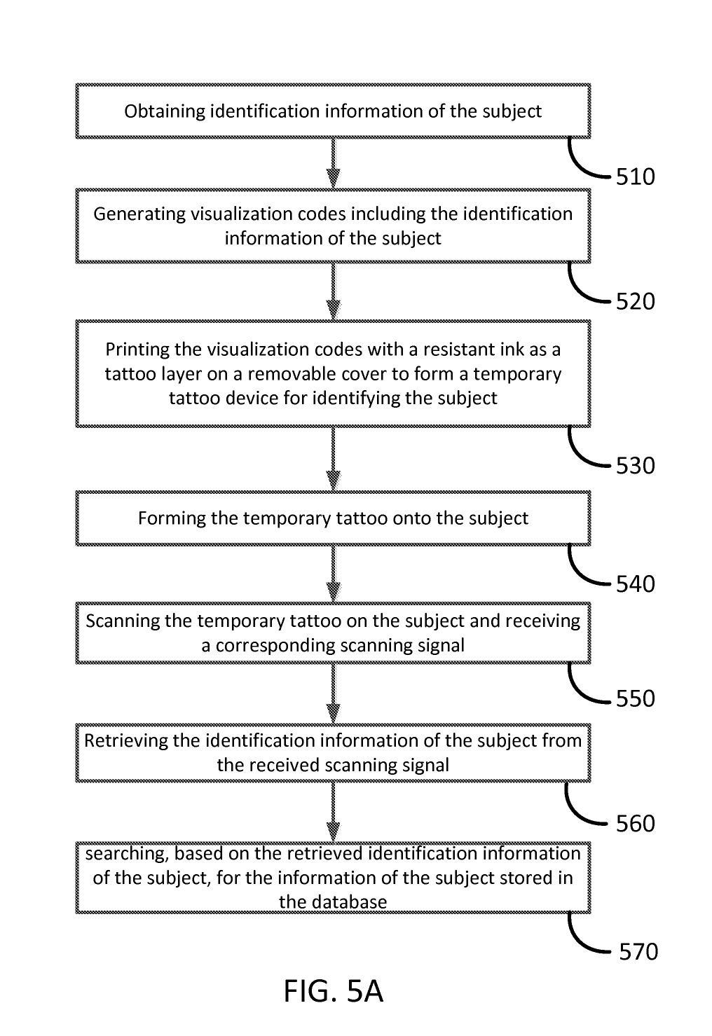

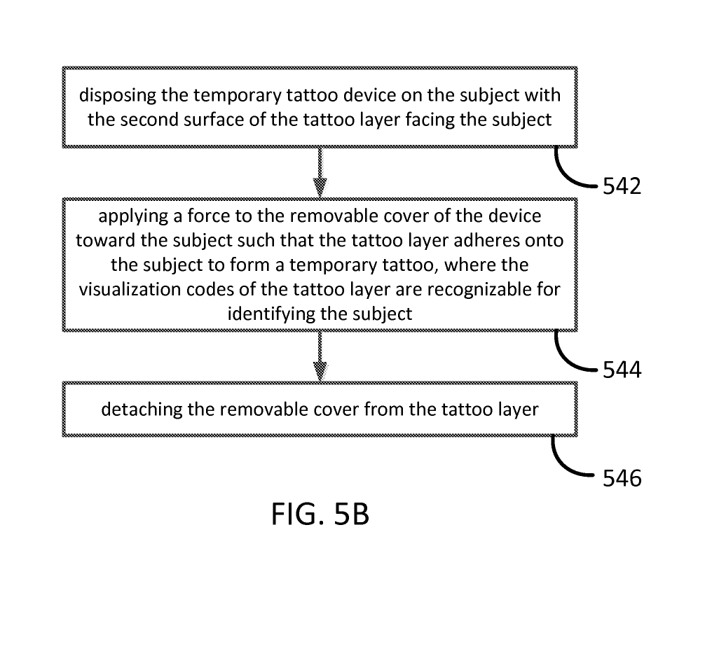

FIG. 5A shows a flowchart of the method of identifying a subject according to one embodiment of the present invention. At step 510, a user (e.g., a doctor, a surgeon, or a nurse) may obtain identification information of the subject, and input the identification information of the subject to a management system such that the management system receives the identification information of the subject. As discussed above, the identification information of the subject may include different information based on the nature of the subject. For example, when the subject is a patient, the user may first contact with the patient, and obtain necessary information for identification of the patient. In certain embodiments, when the user performs medical practice using a computer having an EHR or EMR management system with a regular procedure to obtain the information, the user may obtain the information based on the regular procedure currently used in the EHR or EMR management system.

After the identification information of the subject is received, at step 520, the user may operate the EHR or EMR management software to generate the visualization codes 130 including the identification information of the subject. In certain embodiments, the visualization codes 130 may include one or both of visualization of machine readable codes (e.g., the bar code 132, the QR code 134, or other machine readable codes) and text codes 136. In practice, the user may use a computer having the EHR or EMR management software to enter the information of the patient, and the EHR or EMR management software may generate the visualization codes 130 including the identification information of the patient.

Then, at step 530, the user may operate the EHR or EMR management software to print the visualization codes 130 with a resistant ink as a tattoo layer 110 on a removable cover 120 to form a temporary tattoo device 100 for identifying the subject, where the tattoo layer 110 includes the visualization codes 130 thereon. In practice, the user may operate the EHR or EMR management software to control a printing device, such as a printer, to print the temporary tattoo device 100.

At step 540, the user may form the temporary tattoo onto the subject with the temporary tattoo device 100. FIG. 5B shows a flowchart of forming the temporary tattoo onto the subject according to one embodiment of the present invention. Specifically, the forming of the temporary tattoo may include the following steps: at step 542, the user disposes the temporary tattoo device 100 on the subject 150 with the second surface 114 of the tattoo layer 110 facing the subject 150. At step 544, the user may apply a force to the removable cover 120 of the device toward the subject 150 such that the tattoo layer 110 adheres onto the subject 150 to form a temporary tattoo. Optionally, at step 546, the user may detach the removable cover 120 from the tattoo layer 110. In certain embodiments, as long as the tattoo layer 110 has been adhered onto the subject 150 properly, the visualization codes 130 of the tattoo layer 110 may be recognizable for identifying the subject 150 regardless of the removable cover 120 being detached or not.

Once the temporary tattoo is formed on the subject 150, at step 550, the user may scan the temporary tattoo on the subject and receive a corresponding scanning signal. Specifically, the user may use an optical scanning device, such as a scanner or other compatible scanning device, to scan the visualization codes 130 (e.g., the bar code 132 or the QR code 134) on the temporary tattoo to receive the scanning signal. In certain embodiments, the removable cover 120 may be transparent or semi-transparent such that the visualization codes 130 of the tattoo layer 110 are recognizable through the removable cover 120. Accordingly, as long as the scanning process is performed properly, the scanning signal should include the identification information of the subject 150, which is recognizable by the EHR or EMR management software.

Once the scanner receives the scanning signal, the scanner sends the scanning signal to the EHR or EMR management software, and at step 560, the EHR or EMR management software retrieves the identification information of the subject 150 from the received scanning signal. At step 570, the EHR or EMR management software may search in a corresponding database, based on the retrieved identification information of the subject 150, to find a unique record that matches or associates with the identification information of the subject 150. The unique record that matches or associates with the identification information may include the information of the subject 150. Optionally, when the EHR or EMR management software finds a matching record in the database, the EHR or EMR management software may return to the user with the information pertaining to the subject, and display or act upon the information. When the user is only allowed to view certain information per security policy in place of the EHR or EMR management software, the EHR or EMR management software may return to the user with only the information allowed under the security policy.

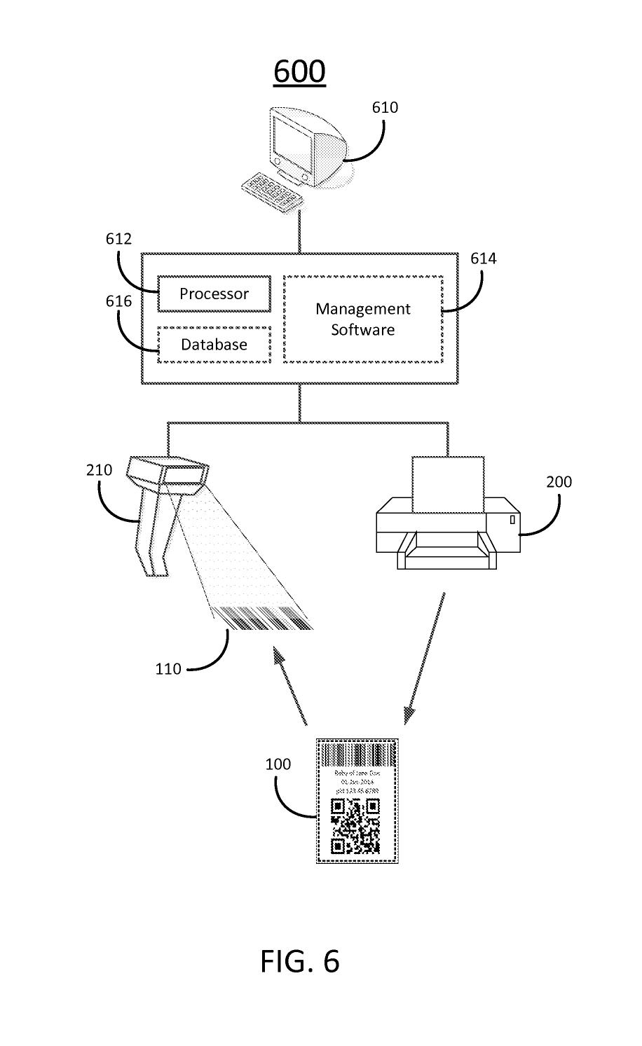

A further aspect of the present invention relates to a system for identifying a subject. In certain embodiments, the system includes a temporary tattoo and a computer system. FIG. 6 shows schematically a system for identifying a subject according to one embodiment of the present invention. As shown in FIG. 6, the system 600 includes a computer system 610, and a temporary tattoo 110 adhering onto a subject (not shown). The temporary tattoo 110 may be any temporary tattoo formed by the temporary tattoo device 100 as described above. Specifically, the temporary tattoo 110 includes visualization codes thereon, and the visualization codes include identification information of the subject.

The computer system 610 is a computing device to control operation of the system 600. In certain embodiments, the computer system 610 may be a general purpose computer system or a computer system specifically designed and programmed to perform the identification of the subject, and may be implemented by one or more computers. Examples of the computers applicable as or to be a part of the computer system 610 may include, without being limited to, desktop computers, laptop computers, portable computing devices such as smartphones, tablets or mobile computers,

As shown in FIG. 6, the computer system 610 includes a processor 612, a management software 614, and a database 616 storing information of the subject. Further, the computer system 610 has a plurality of peripheral devices, such as a printing device 200 and an optical scanning device 210. In certain embodiments, the computer system 610 may include other hardware and/or software components which are deemed necessary for the operation of the computer system 610, such as one or more memory modules, one or more storage devices, interconnection interfaces and buses between the components, one or more input/output (I/O) devices, and one or more software application programs executable on the computer system 610.

The processor 612 is a processing unit to control operation and to execute instructions of the computer system 610. The processor 612 may execute the software programs or applications of the computer system 610, such as the management software 614. In certain embodiments, the processor 612 may be a central processing unit (CPU).

The management software 614 is a software program controlling the management of data related to the subjects to be identified. In certain embodiments, the management software 614 may be an EHR or EMR management software. Specifically, when the management software 614 is executed at the processor 612, a user (e.g., a doctor, a surgeon or a nurse) may operate the executed management software 614 to perform certain operations for identifying a subject. In certain embodiments, the operations may include the steps described in FIG. 5A.

The database 616 is a data store which stores information of the subject. In certain embodiments, the database 616 stores all information of a plurality of subjects which may be identifiable using the management software 614. For example, the database 616 may store all information of the patients in a hospital. The information of each patient includes the identification information of the patient, such that the management software 614 may use the identification information to search for matching records.

In summary, aspects of the present invention relate to a device and method for identifying a subject. In certain embodiments, the device includes a tattoo layer and a removable cover. The tattoo layer is formed with a resistant material, and has a first surface and an opposite, second surface attachable onto the subject. The removable cover is detachably covering the first surface of the tattoo layer. The tattoo layer includes visualization codes thereon, and the visualization codes include identification information of the subject. The resistant material is adhesive to be adhered onto the subject, and is dissolvable only in a chemical solvent such that the information layer is only removable from the subject using the chemical solvent. To form the tattoo layer on the removable cover, a user may use a computer system to operate a management software to receive the identification information of the subject, to generate the visualization codes including the identification information of the subject, and to print the visualization codes with the resistant material as the tattoo layer on the removable cover. In certain embodiments, the visualization codes include visualization of optical machine readable codes, such as a bar code, a quick response (QR) code, or any other forms of computer codes. In certain embodiments, the visualization codes may include text codes. In certain embodiments, the device may be used in medical fields as a medical temporary tattoo, which is used for identifying a medical subject. In comparison of medical bracelets or other identifying devices, the temporary tattoo is not easily to be removed and is more reliable.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A device for identifying a subject, comprising:
a tattoo layer having a first surface and an opposite, second surface attachable onto a subject to form a temporary tattoo for identifying a subject, wherein the tattoo layer is formed with a resistant material being adhesive such that the temporary tattoo adheres onto the subject, and wherein the tattoo layer comprises visualization codes thereon, and the visualization codes comprise identification information of the subject; and
a removable cover detachably covering the first surface of the tattoo layer.

2. The device of claim 1, wherein the resistant material is dissolvable only in a chemical solvent such that the temporary tattoo is only removable from the subject using the chemical solvent.

3. The device of claim 1, wherein the resistant material comprises a resistant ink, and the tattoo layer is formed on the removable cover by printing with the resistant ink.

4. The device of claim 1, wherein the removable cover is transparent or semi-transparent such that the visualization codes of the tattoo layer are recognizable through the removable cover.

5. The device of claim 4, wherein the removable cover comprises a piece of paper or plastic.

6. The device of claim 1, wherein the visualization codes comprise at least one of visualization of optical machine readable codes and text codes.

7. The device of claim 6, wherein the visualization of optical machine readable codes comprise at least one of a bar code and a quick response (QR) code.

8. The device of claim 1, wherein the temporary tattoo is formed onto the subject by:
disposing the device on the subject with the second surface of the tattoo layer facing the subject;
applying a force to the removable cover of the device toward the subject such that the tattoo layer adheres onto the subject to form the temporary tattoo, wherein the visualization codes of the tattoo layer are recognizable for identifying the subject; and
detaching the removable cover from the tattoo layer.

9. A system for identifying a subject, comprising:
a temporary tattoo adhering onto the subject and being formed with a resistant material, wherein the temporary tattoo comprises visualization codes thereon, and the visualization codes comprise identification information of the subject; and
a computer system having a processor, an optical scanning device, a printing device, a management software and a database storing information of the subject, wherein the information of the subject comprises the identification information of the subject;
wherein the management software, when executed at the processor, is configured to perform the following operations:
receiving an input of the identification information of the subject;
generating the visualization codes comprising the identification information of the subject;
controlling the printing device to print the visualization codes with the resistant material as a tattoo layer on a removable cover to form a temporary tattoo device, wherein the resistant material is adhesive such that the tattoo layer is attachable onto the subject to form the temporary tattoo;
controlling the optical scanning device to scan the temporary tattoo on the subject and to receive a corresponding scanning signal, wherein the received scanning signal contains the identification information of the subject;
retrieving the identification information of the subject from the received scanning signal; and
searching, based on the retrieved identification information of the subject, for the information of the subject stored in the database to identify the subject.

10. The system of claim 9, wherein the resistant material is dissolvable only in a chemical solvent such that the temporary tattoo is only removable from the subject using the chemical solvent.

11. The system of claim 9, wherein the printing device is an ink jet printer or a laser printer, and the optical scanning device is a scanner.

12. The system of claim 9, wherein the temporary tattoo is formed onto the subject by:
disposing the temporary tattoo device on the subject with the tattoo layer facing the subject;
applying a force to the removable cover of the device toward the subject such that the tattoo layer adheres onto the subject to form the temporary tattoo, wherein the visualization codes of the tattoo layer are recognizable for identifying the subject; and
detaching the removable cover from the tattoo layer.

13. The system of claim 9, wherein the removable cover is transparent or semi-transparent such that the visualization codes of the tattoo layer are recognizable through the removable cover.

14. The system of claim 9, wherein the visualization codes comprise at least one of visualization of optical machine readable codes and text codes.

15. The system of claim 14, wherein the visualization of optical machine readable codes comprise at least one of a bar code and a quick response (QR) code.

16. A method for identifying a subject, comprising:
receiving identification information of the subject;
generating visualization codes comprising the identification information of the subject;
printing the visualization codes with a resistant ink as a tattoo layer on a removable cover to form a temporary tattoo device for identifying the subject, wherein the resistant ink is adhesive such that the tattoo layer is capable of adhering onto the subject to form a temporary tattoo, and is dissolvable only in a chemical solvent such that the tattoo layer is only removable from the subject using the chemical solvent;
forming the temporary tattoo onto the subject with the temporary tattoo device;
scanning the temporary tattoo on the subject and receiving a corresponding scanning signal, wherein the received scanning signal contains the identification information of the subject;
retrieving the identification information of the subject from the received scanning signal; and
searching, based on the retrieved identification information of the subject, for the information of the subject stored in the subject to identify the subject.

17. The method of claim 16, wherein the removable cover is transparent or semi-transparent such that the visualization codes of the tattoo layer are recognizable through the removable cover.

18. The method of claim 16, wherein the step of forming the temporary tattoo onto the subject comprises:
disposing the temporary tattoo device on the subject with the tattoo layer facing the subject;
applying a force to the removable cover of the device toward the subject such that the tattoo layer adheres onto the subject to form the temporary tattoo, wherein the visualization codes of the tattoo layer are recognizable for identifying the subject; and
detaching the removable cover from the tattoo layer.

19. The method of claim 16, wherein the visualization codes comprise at least one of visualization of optical machine readable codes and text codes.

20. The method of claim 19, wherein the visualization of optical machine readable codes comprise at least one of a bar code and a quick response (QR) code.
